(19) United States
(12) Patent Application Publication
(10) Pub. No.: US 2005/0022582 A1
(43) Pub. Date: Feb. 3, 2005

(54) Engine knock sensor

(76) Inventors: Luis F. Barron, El Paso, TX (US); Viswanathan Subramanian, El Paso, TX (US)

Correspondence Address: DELPHI TECHNOLOGIES, INC., M/C 480-410-202, PO BOX 5052, TROY, MI, 48007, US

(21) Appl. No.: 10/632,326

(22) Filed: Aug. 1, 2003

(51) Int. Cl. G01L 23/22; F02P 5/152

(52) U.S. Cl. 73/35.01; 29/525.11; 123/406.29

(57) ABSTRACT

An engine knock sensor, includes a sleeve having a base and a threaded end opposite the base. A transducer is disposed around the sleeve. Moreover, a load washer is disposed around the sleeve adjacent to the transducer. A nut is threaded onto the threaded end of the sleeve and provides a compressive force on the load washer. Further, a seal groove is formed in the sleeve. A ring-shaped seal is disposed in the seal groove and prevents liquid from entering the knock sensor.

### TECHNICAL FIELD

The present invention relates to engine knock sensors.

### BACKGROUND OF THE INVENTION

Most vehicles today are equipped with numerous sensors that are used to regulate the operation of the engine. One such sensor is an engine knock sensor. Typically, an engine knock sensor is mounted on an engine block, e.g., on the intake manifold or a cylinder head, and it produces an output voltage in proportion to the engine vibrations caused by uneven burning of fuel, a.k.a. knock. When knocking occurs, a microprocessor connected to the knock sensor can adjust the engine timing in order to minimize or eliminate the knocking.

Conventional knock sensors typically include a sleeve, insulating materials, a piezoelectric transducer, a load washer, a spring washer and a nut. During assembly, each of the components are installed over the sleeve in a predetermined order and then, secured using the nut. The nut engages threads on the sleeve and compresses the spring washer to apply the force needed for the sensor to operate. The sleeve assembly is then over molded with a thermoplastic material to form the sensor's body and hermetically seal all of the internal components. It happens that due to the different coefficients of thermal expansion of the sleeve and the thermoplastic, some fluid can wick in between the sleeve and plastic. To minimize wicking, the base of the sleeve is formed with ribs into which the thermoplastic flows. The ribs increase the leak path length and provide a convoluted path that intruding fluids must travel in order to reach the internal components. The additional machining required to form the ribs increases the costs associated with the conventional knock sensors.

The present invention has recognized these prior art drawbacks, and has provided the below-disclosed solutions to one or more of the prior art deficiencies.

### SUMMARY OF THE INVENTION

An engine knock sensor includes a sleeve. A threaded end is established by the sleeve. A transducer is disposed around the sleeve and a load washer is disposed around the sleeve adjacent to the transducer. Moreover, a nut is threaded onto the sleeve and provides a compressive force on the load washer. A seal groove is formed in the sleeve and a ring-shaped seal is disposed in the seal groove. The ring-shaped seal prevents liquid from entering the knock sensor.

In a preferred embodiment, the sleeve establishes a base opposite the threaded end of the sleeve and the seal groove is formed in the base. Also, a lower terminal is disposed around the sleeve beneath the transducer and an upper terminal is disposed around the sleeve above the transducer. Preferably, a lower insulator is disposed around the sleeve beneath the lower terminal and an upper insulator is disposed around the sleeve above the upper terminal. Additionally, a housing surrounds the sleeve, the transducer, the terminals, the insulators, the nut, and the ring-shaped seal. In a preferred embodiment, the ring-shaped seal is an O-ring.

In another aspect of the present invention, an engine control system includes a microprocessor. An ignition system is electrically connected to the microprocessor and a knock sensor is electrically connected to the microprocessor. The knock sensor is sealed by a ring-shaped seal.

In yet another aspect of the present invention, a method for making an engine knock sensor includes providing a sleeve that has a base and a threaded end opposite the base. A seal groove is formed around the base and a ring-shaped seal is installed in the seal groove. A transducer is disposed around the sleeve above the ring-shaped seal. A load washer is disposed on the sleeve above the transducer. Further, a threaded nut is installed on the threaded end of the sleeve.

In still another aspect of the present invention, an engine knock sensor includes a transducer. A sleeve supports the transducer and a plastic housing is over molded on the sleeve to protect the transducer. In this aspect of the present invention, one and only one continuous flat interface that defines a single plane is between the sleeve and the housing.

The present invention will now be described, by way of example, with reference to the accompanying drawings, in which:

### BRIEF DESCRIPTION OF THE DRAWINGS

The present invention will now be described, by way of example, with reference to the accompanying drawings, in which:

FIG. 1 is a cross-section view of an engine knock sensor;

FIG. 2 is a cross-section view of an engine knock sensor sleeve;

and

FIG. 3 is a block diagram of an engine control system.

### DESCRIPTION OF THE PREFERRED EMBODIMENT

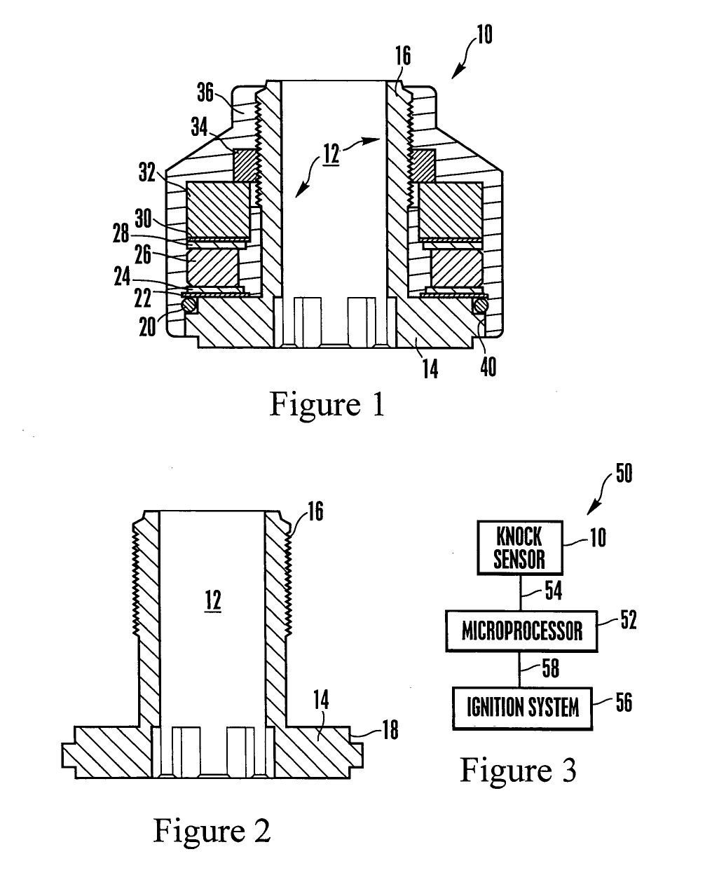

Referring initially to FIG. 1, an engine knock sensor is shown and is generally designated 10. FIG. 1 shows that the knock sensor 10 includes a generally cylindrical hollow sleeve 12. As shown, the sleeve 12 forms a radially enlarged base 14 and a threaded end 16 opposite the enlarged base 14. Referring briefly to FIG. 2, it can be seen that the enlarged base 14 of the sleeve 12 is preferably formed with a seal groove 18 on the interior side of the enlarged base 14 around the outer periphery of the base 14.

Returning to FIG. 1, a ring shaped seal 20, e.g., an O-ring, is disposed in the seal groove 18. A generally disk-shaped lower insulator 22 is installed around the sleeve 12 on top of the base 14. Moreover, a generally disk-shaped lower terminal 24 is stacked on the lower insulator 22. FIG. 1 shows a piezoelectric transducer 26 on top of the lower terminal 24. It is to be understood that the piezoelectric transducer 26 can emit a signal when vibrated, e.g., while an engine is knocking. A generally disk-shaped upper terminal 28 is disposed around the sleeve 12 on top of the transducer 26 such that the transducer 26 is sandwiched between the terminals 24, 28. As shown, a generally disk-shaped upper insulator 30 is stacked on top of the upper terminal 28. Moreover, a generally disk-shaped load washer 32 is installed on top of the upper insulator 30.

FIG. 1 further shows a threaded nut 34 that is threaded onto the threaded end 16 of the sleeve 12. The nut 34 provides a compressive force on the transducer 32. After the elements are assembled as described above, a preferably plastic housing 36 is over molded around the elements. The plastic housing 36 protects the interior components. Additionally, the ring-shaped seal 20 minimizes the intrusion of fluid into the interior of the sensor 10. As such, the need for ribs machined in the base 14 of the sleeve 12 is obviated and the cost of the knock sensor 10 is reduced. As shown, without any ribs machined in the base 14 of the sleeve 12 a continous flat interface 40 is established between the base 14 of the sleeve 12 and the housing 36. The interface defines a single plane around the outer periphery of the base 14 between the sleeve and the housing 36.

FIG. 3 shows a block diagram of an engine control system 50 in which the knock sensor 10 can be incorporated. As shown in FIG. 3, the knock sensor 10 is connected to a microprocessor 52 via electrical line 54. In a preferred embodiment, the microprocessor 52 is a powertrain control module (PCM), but it is to be appreciated that it can be any type of microprocessor. FIG. 3 further shows an ignition system 56 connected to the microprocessor 52 via electrical line 58. It is to be understood that when the microprocessor 52 receives a signal from the knock sensor 10 indicating that the engine is knocking, it sends a signal to the ignition system 56 in order to adjust the engine timing until the knocking is eliminated.

While the particular ENGINE KNOCK SENSOR as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. An engine knock sensor, comprising:
a sleeve;
a threaded end established by the sleeve;
a transducer disposed around the sleeve;
a load washer disposed around the sleeve adjacent to the transducer;
a nut threaded onto the sleeve, the nut providing a compressive force on the load washer;
a seal groove formed in the sleeve; and
a ring-shaped seal disposed in the seal groove, the ring-shaped seal preventing liquid from entering the knock sensor.

2. The engine knock sensor of claim 1, further comprising:
a base established by the sleeve opposite the threaded end of the sleeve; and
wherein the seal groove is formed in the base.

3. The engine knock sensor of claim 2, further comprising:
a lower terminal disposed around the sleeve beneath the transducer; and
an upper terminal disposed around the sleeve above the transducer.

4. The engine knock sensor of claim 3, further comprising:
a lower insulator disposed around the sleeve beneath the lower terminal; and
an upper insulator disposed around the sleeve above the upper terminal.

5. The engine knock sensor of claim 4, further comprising:
a housing surrounding the sleeve, the transducer, the terminals, the insulators, the nut, and the ring-shaped seal.

6. The engine knock sensor of claim 5, wherein the ring- shaped seal is an O-ring.

7. An engine control system, comprising:
at least one microprocessor;
at least one ignition system electrically connected to the microprocessor; and
at least one knock sensor electrically connected to the microprocessor, the knock sensor being sealed by a ring-shaped seal.

8. The system of claim 7, wherein the knock sensor comprises:
a sleeve;
a threaded end established by the sleeve;
a transducer disposed around the sleeve;
a load washer disposed around the sleeve adjacent to the transducer;
a nut threaded onto the sleeve, the nut providing a compressive force on the load washer;
a seal groove formed in the sleeve, the ring-shaped seal being disposed in the seal groove, the ring-shaped seal preventing liquid from entering the knock sensor.

9. The system of claim 8, wherein the knock sensor further comprises:
a base established by the sleeve opposite the threaded end of the sleeve; and
wherein the seal groove is formed in the base.

10. The system of claim 9, wherein the knock sensor further comprises:
a lower terminal disposed around the sleeve beneath the transducer; and
an upper terminal disposed around the sleeve above the transducer.

11. The system claim 10, wherein the knock sensor further comprises:
a lower insulator disposed around the sleeve beneath the lower terminal; and
an upper insulator disposed around the sleeve above the upper terminal.

12. The system of claim 11, wherein the knock sensor further comprises:
a housing surrounding the sleeve, the transducer, the terminals, the insulators, the nut, and the ring-shaped seal.

13. The system of claim 12, wherein the ring-shaped seal is an O-ring.

14. A method for making an engine knock sensor, comprising:
providing a sleeve having a base and a threaded end opposite the base;
forming a seal groove around the base;
installing a ring-shaped seal in the seal groove;
disposing a transducer around the sleeve above the ring-shaped seal;
disposing a load washer on the sleeve above the transducer;
and
installing a threaded nut on the threaded end of the sleeve.

15. The method of claim 14, further comprising:
disposing a lower terminal around the sleeve beneath the transducer; and
disposing an upper terminal around the sleeve above the transducer.

16. The method of claim 15, further comprising:
disposing a lower insulator around the sleeve beneath the lower terminal; and
disposing an upper insulator around the sleeve above the upper terminal.

17. The method of claim 16, further comprising the act of:
molding a housing around the sleeve, the transducer, the terminals, the insulators, the nut, and the ring-shaped seal.

18. The method of claim 17, wherein the ring-shaped seal is an O-ring.

19. An engine knock sensor, comprising:
a transducer;
a sleeve supporting the transducer;
a plastic housing over molded on the sleeve to protect the transducer;
wherein one and only one continuous flat interface defining a single plane is between the sleeve and the housing.

20. The engine knock sensor of claim 19, further comprising:
a seal groove formed in the sleeve above the continuous flat interface.

21. The engine knock sensor of claim 20, further comprising:
a ring-shaped seal disposed in the seal groove, the ring-shaped seal preventing liquid from entering the knock sensor.

22. The engine knock sensor of claim 21, wherein the ring-shaped seal is an O-ring.
